(19) United States
(12) Patent Application Publication
(10) Pub. No.: US 2009/0071734 A1
(43) Pub. Date: Mar. 19, 2009

(54) Method and Apparatus for Generating Electrical Power with Compressed Air and Vehicle Incorporating the Same

(76) Inventor: Earl R. Hurkett, Littleton, CO (US)

Correspondence Address: Leyendecker & Lemire, LLC, C/O PORTFOLIO IP, P.O. BOX 52050, MINNEAPOLIS, MN, 55402, US

(21) Appl. No.: 12/113,453

(22) Filed: May 1, 2008

Related U.S. Application Data
(60) Provisional application No. 60/915,252, filed on May 1, 2007.

(51) Int. Cl. B60L 11/00; F01D 15/10; H02P 9/04

(52) U.S. Cl. 180/65.31; 290/36 R; 290/52; 318/140; 903/906

(57) ABSTRACT

An apparatus for generating electrical power using compressed gas is described. The apparatus includes a source of compressed gas, such as one or more tanks. A compressed gas powered turbine and an operatively coupled electrical generator are also provided. The compressed gas is blown onto vanes of the turbine in intermittent pulses or shots of compressed air instead of in a continuous stream to facilitate the most efficient use of the gas. The electrical power can be stored in batteries or capacitors for later use, or in a vehicle utilizing the apparatus, the generated electrical current can be fed directly to electrical motors that power the vehicle's wheels.

### REFERENCE TO RELATED APPLICATIONS

This application claims priority to and incorporates by reference herein provisional patent application 60/915,252 filed on May 1, 2007 having same title and the same inventor as this application.

### FIELD OF THE INVENTION

The invention pertains to the generation of electrical power utilizing compressed gas and motorized vehicles incorporating the same.

### BACKGROUND

Portable power generation is used in many applications, such as powering a construction site, emergency back up power, recreational uses such as powering a camper, and the ubiquitous automobile. In many cases, especially in automobiles, portable power is generated with an internal combustion engine burning some type of fuel. Alternatively, power can be stored in batteries that provide a portable source of electrical power. With growing concerns over dwindling fossil fuel supplies and CO2 emissions, new ways of providing portable power are needed.

At least in the case of the automobile several attempts have been made to limit the use of fuel to provide portable power. For instance a hybrid electric vehicle incorporates an electric motor and a small bank of batteries to provide auxiliary power in urban settings where pollution is a particular problem. However, hybrid vehicles still rely on internal combustion engines, which burn fuel, to drive a generator for charging the batteries. Purely electric vehicles take this one step further and rely solely on electricity stored in batteries. Purely electric vehicles do have their disadvantages in that batteries contain toxic metals and chemicals. Furthermore, in order for an electric vehicle to have acceptable range and performance it must have a large bank of batteries, which come with a significant weight disadvantage. Also, disposal of batteries is of great concern to environmentalists.

Another way to provide portable power generation is to store potential energy in the form of compressed air. Compressed air can then be used to run an air motor or an air turbine. This type of portable power generation has been used in vehicles which incorporate air motors and turbines. For instance U.S. Pat. No. 6,054,838 to Tsatsis describes an apparatus for providing portable electrical power generation by coupling an air-powered turbine to a generator, which charges batteries that are then coupled to electric motors located at each wheel. Compressed air power generation has the advantage of emitting no pollution and creating no carbon dioxide—it simply emits air. Compressed air power generation eliminates the need for large battery banks, which pose a potential environmental hazard. Compressed air power generation also eliminates the need to burn fuel. Furthermore, compressed air can be compressed using a compressor run with electricity from a standard wall outlet. While it still requires energy to compress the tanks, the power generation used to charge the tanks can be provided by other sources of energy such as nuclear power, wind power, and coal or natural gas burning power plants where application of carbon dioxide scrubbing systems is more efficient and economical.

Compressed air vehicles are, however, currently limited in range due to storage issues with compressed gases. There is also room for improvement in conserving the compressed air, and improvements in air metering. Accordingly, there is a need for improved compressed air portable power generation. The present invention is directed to meeting these needs.

### BRIEF DESCRIPTION OF THE DRAWINGS

FIG. 1 is a diagrammatic view in perspective of a compressed air/gas vehicle according to a first exemplary embodiment of the present invention, where the vehicle outline is shown in phantom;

FIG. 2 is a schematic representation of the compressed air/gas vehicle shown in FIG. 1 further detailing the electrical control therein;

FIG. 3 is a side view in elevation, with the turbine wheel shown in partial cross-section, illustrating the construction, according to a first exemplary embodiment, of the air turbine shown in FIG. 1;

FIG. 4 is an enlarged perspective view of the air turbine and generator shown in FIG. 3;

FIG. 5 is a side view in elevation illustrating an alternate means of coupling the generator to the turbine;

FIG. 6 is a perspective view showing the air-shot device;

FIG. 7 is a cross-sectional view taken about line 7-7 in FIG. 6, which illustrates a first alternate construction of the air-shot device;

FIG. 8 is a cross-sectional view similar to FIG. 7, which illustrates a second alternate construction of the air-shot device;

FIG. 9 is a cross-sectional view similar to FIG. 7, which illustrates a third alternate construction of the air-shot device;

FIG. 10 is a cross-sectional view similar to FIG. 7, which illustrates a fourth alternate construction of the air-shot device;

FIG. 11 is a partial side view of the turbine with a cut away showing the curved fins of the turbine and the air shot device engaged;

FIG. 12 is a partial side view of the turbine illustrating the engagement of the air-shot guide with the turbine;

FIG. 13 is an enlarged partial view of the air-shot guide engaged with the turbine;

FIG. 14 is a perspective cutaway view of the turbine wheel illustrating the construction of the fins, guide grooves, and pulley groove;

FIG. 15 is a schematic representation of a compressed air/gas vehicle according to a second exemplary embodiment of the present invention;

FIG. 16 is a partial schematic representation of a compressed air/gas vehicle according to a third exemplary embodiment of the present invention; and

FIG. 17 is a partial schematic representation of a compressed air/gas vehicle according to a fourth exemplary embodiment of the present invention.

### DETAILED DESCRIPTION OF THE EXEMPLARY EMBODIMENTS

Generating electrical power with compressed air turbines has many advantages. For instance, compressed air turbines emit zero emissions with relatively simple and robust technology as compared with purely electric vehicles and hybrid vehicles. Provided herein is a method and apparatus for generating electrical power with a compressed air turbine. The exemplary embodiments illustrate improvements and advantages over the existing technology in the areas of compressed air/gas conservation, energy regeneration control, and improvements in air/gas metering.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation” and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

The terms “air” and “gas” have been used generally interchangeably herein. As contemplated by several of the described embodiments, the gas or mixture of gases most likely to be used is air; however, other embodiments are contemplated that utilized other compressed gasses or mixtures thereof. For instance, the embodiments utilizing a liquid gas are likely to utilize nitrogen as opposed to liquefied air.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

### Embodiments of a Compressed Gas Apparatus for Generating Electrical Power and an Associated Vehicle

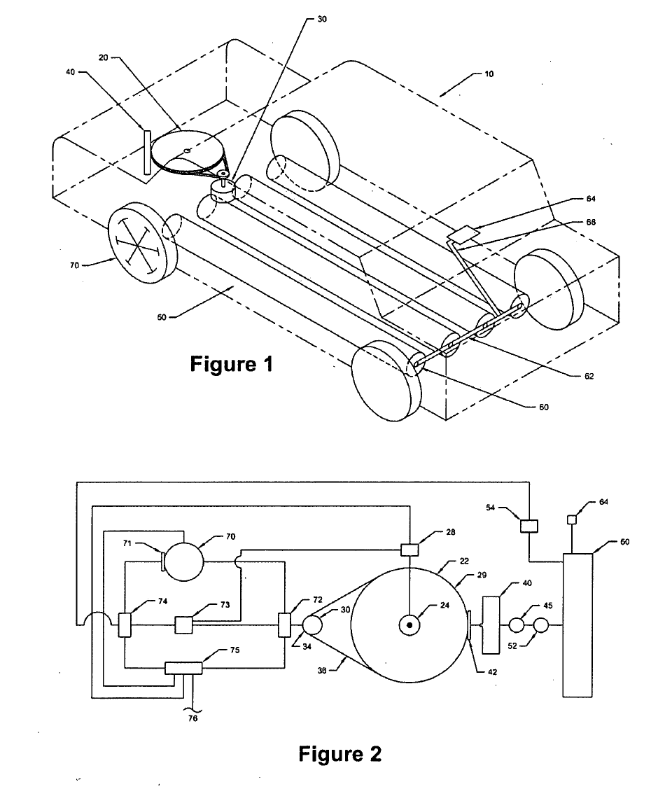

There are many applications where clean portable electric power is advantageous. For instance, FIG. 1 illustrates a vehicle incorporating the compressed air turbine generation system according to a first exemplary embodiment. The exemplary embodiments will be described with respect to a vehicle without limitation. It should be understood that the portable power generation system described herein can be used in other application where portable power is needed. Vehicle 10 includes a turbine 20, which is coupled to a generator 30. The turbine 20 is powered with compressed gas, in this case air, through an air shot device 40. Air shot device 40 controls the flow of gas from tank array 50. Tank array 50 includes several tanks 60 coupled together with a manifold 62. In this embodiment, the tanks are filled either via a compressed air/gas source through inlet and cap assembly 64 and line 66 or with an onboard compressor 54 (see FIG. 2). Electricity generated with generator 30 is then used to power individual wheel motor(s) 70. In this embodiment, the air turbine 20 is oriented horizontally with respect to the vehicle 10. However, the orientation of turbine 20 could be adjusted depending on the design of the vehicle and where it best packages within the vehicle. It should also be noted that tank array 50 is oriented longitudinally in vehicle 10, however, like the turbine 20, the tanks can be arranged in a configuration suitable to the design of the vehicle.

With reference to FIG. 2, the power from the generator 30 travels to a voltage regulator 72, which depending on demand sends power to the wheel motor(s) 70, battery(s) 73, and/or capacitor pack (or super capacitor(s)) 75. If the vehicle is idling, regulator/controller 72 diverts power to the battery 73 or capacitors 75 or signals the air shot device 40 to use fewer pre-measured air/gas releases, or shots, to drive turbine 22 because the generator 30 is not under load, thereby conserving potential energy in the tank array 50. The battery 73 and/or capacitors 75 are used for operating the starter motor 28 and/or electrical service needs, such as lights. The power generated from regenerative braking coil 71 is sent to a second voltage regulator 74, which depending on needs, charges the battery 73 and/or the capacitor pack 75. Capacitor pack 75 and battery 73 may be charged by connecting the system to an electrical wall outlet via connector 76. The capacitors 75 can also be used to start the wheel motor(s) 70 and/or starter motor 28. The voltage regulator 74 can also send power to a small on-board air/gas compressor 54, which can charge tank array 50. The compressor 54 can also be plugged into any electrical outlet when the car is not operating.

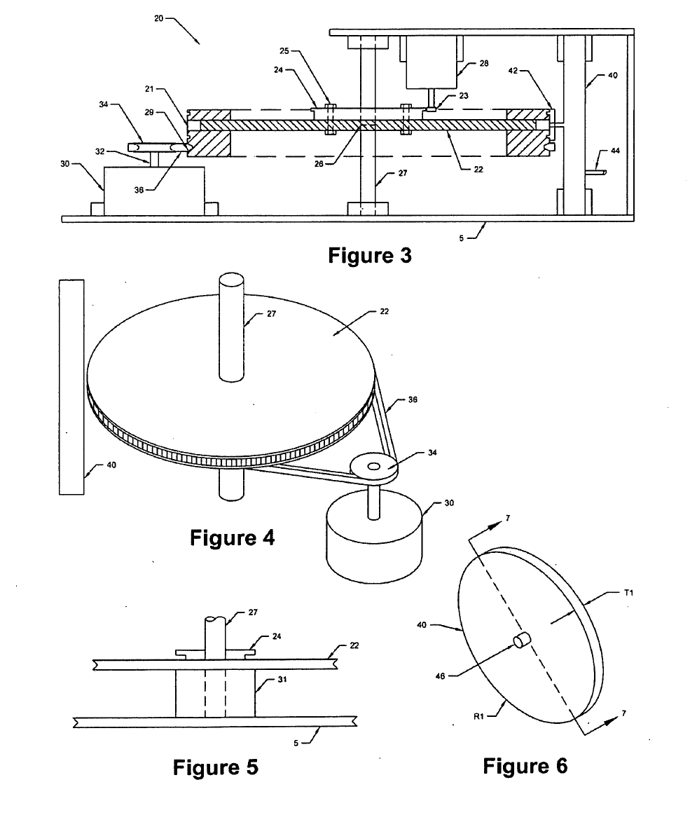

With reference to FIG. 3, the air turbine assembly is illustrated in more detail. The turbine wheel 22 rotates on low-friction bearings 26 about stationary axle 27. The turbine wheel 22 is coupled to the generator with v-belt 36 (see FIG. 4). V-belt 36 rides in groove 29, which is machined on the turbine wheel 22, and also on v-belt pulley 34, which is attached to generator shaft 32. Air turbine 22 is powered with compressed gas, which is stored in tanks 50 as shown in FIG. 1, which is then carried to the air shot device 40 where it enters through airline 44. The compressed air/gas exits the air shot device 40 through air shot guide set 42 where the compressed gas impinges on the recessed turbine fins 21 which are spaced around the perimeter of the turbine wheel.

In order to conserve compressed air/gas at startup the turbine assembly 20 also includes a starter motor 28. Starter motor 28 is similar to a typical automotive starter where the starter momentarily engages a flywheel and then disengages from the flywheel after the engine is at speed. In this case, starter motor 28 engages flywheel 24 via a gear 23, which engages teeth formed in the flywheel 24. Flywheel 24 is secured to the turbine wheel with bolts or rivets 25. Because the starter motor 28 engages the flywheel 24 and starts the turbine 22 and generator 30 up to an RPM close to that required to operate the generator, the air shot system 40 only needs to maintain the momentum of the system. This is accomplished through regulated and measured minimum shots of air/gas. This saves starting the entire system up off of the tank array 50, which helps maintain more potential energy in the tanks. As soon as starter motor 28 brings the system up to speed, the capacitors 75 start up wheel motor(s) 70. Thus, the need for multiple batteries, or in some embodiments any batteries, is eliminated.

In an alternate arrangement the generator 30 could be a combination starter and generator. Accordingly, starter 28 could be eliminated. In another alternate arrangement the generator or a combination generator/starter 31 could be arranged coaxially with turbine 22 as is show in FIG. 5. In this case the turbine 22 may be mounted to the shaft 27 which would be rotatable.

The air shot device, as shown in FIG. 6, is a cylindrical disc shaped plenum/reservoir, which holds the correct volume of compressed air/gas for subsequent release onto turbine blades 21 through nozzle port 46. The volume of air shot device 40 is defined by radius RI and its thickness TI. Another variation of the air shot is described with more detail with reference to FIG. 7 in which the reservoir is generally frustoconically-shaped to facilitate increasing the velocity of air shot as it exits the nozzle port 46. Compressed air/gas is transported from the tanks 50 to air shot 40 via airline 43. Air tanks 50 store compressed air at a pressure, for example, between 3,000 and 10,000 PSI. The compressed gas is regulated from tank pressure with regulator 45. Regulator 45 reduces the tank pressure to a lower pressure in order to conserve the volume of gas in the tanks. Regulated gas flows from the regulator 45 through airlines 44 to fill volume 100 of air shot device 40. The system also includes system shut-off valve 52 (see FIG. 2) to conserve compressed air when the vehicle is not in operation.

Gas flow from volume 100 to the nozzle is controlled with valve assembly 81. In this construction, valve assembly 81 is a solenoid actuated pentile valve. External solenoid 80 acts on valve stem 84 which is in turn connected to pentile 86. When solenoid 80 is energized, it pulls on valve stem 84 and thereby pulls on pentile 86 creating opening 87 between pentile 86 and valve seat 88. Valve stem 84 is supported by valve stem guide 82. The gas flows through airline 46 to nozzle 90 (see FIG. 12). Also, airline 46 has either a quick connect fitting or threaded fitting 48 for attaching the nozzle guide 42 (see FIG. 3). As mentioned above the nozzle port is located at the apex of the frustoconical reservoir 100 and as such is accelerated to a high velocity as it exits therethrough. It is appreciated that the design of the penile valve assembly allows the air shot to flow through the reservoir and exit therefrom without substantial obstruction that would otherwise rob the air shot of potential energy before it has impinged on the turbine. Several of the other air shot device embodiments described below also utilize valves that minimize air flow obstructions.

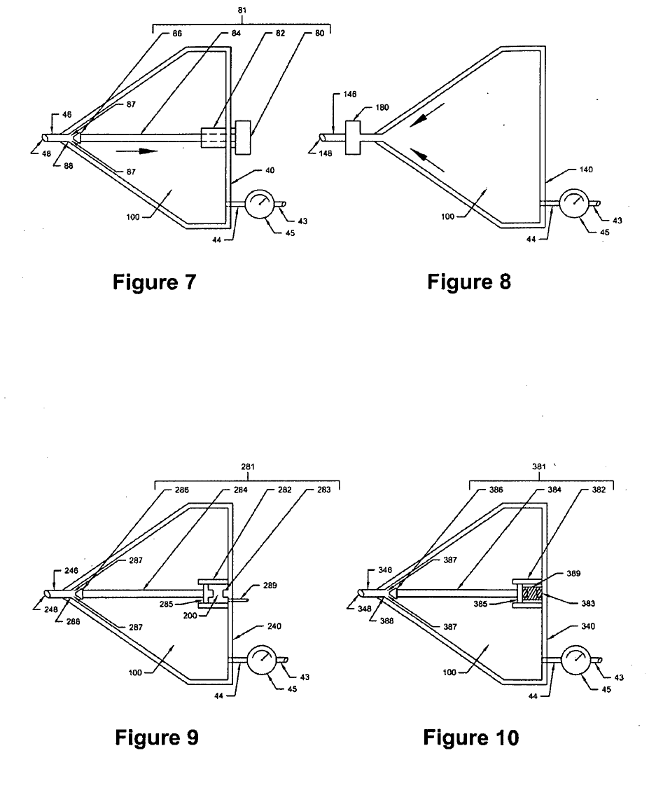

FIG. 8 illustrates a second alternate construction of the air shot device. Air shot device 140 is similar to that shown in FIG. 7; however, the valve assembly is connected between the plenum volume 100 and airline 146. Valve 180 is of a standard design commonly used for airflow control. A third alternate construction of the air shot device is illustrated in FIG. 9. Again, the release of air from volume 100 is controlled with valve assembly 281, which is similar to the solenoid valve assembly shown in FIG. 7. However, the solenoid is replaced with a piston and cylinder arrangement. In this construction, valve assembly 281 is comprised of a cylinder 282 with a piston 285, which travels therein. The pentile 286 and valve stem 284 are connected to piston 285. Air/gas pressure in volume 200 is provided through port 289. By providing varying air/gas pressure to port 289 the differential in air/gas pressure across piston 285 causes the valve stem 284 to move either away from or towards seat 288 thereby creating opening 287 for gas flow. The maximum stroke of valve assembly 281 is controlled by adjusting screw 283. The fourth alternate construction of the air shot device is similar to that shown in FIG. 9 and is described with reference to FIG. 10. Valve assembly 381 is comprised of a cylinder 382 with piston 385 which travels therein. In this case the compensating force used to maintain the valve in a closed position is provided through spring 389. When the air/gas pressure in volume 100 is sufficient to overcome the spring force of 389 the valve stem 384 moves along with pentile 386 away from seat 388 thereby creating opening 387.

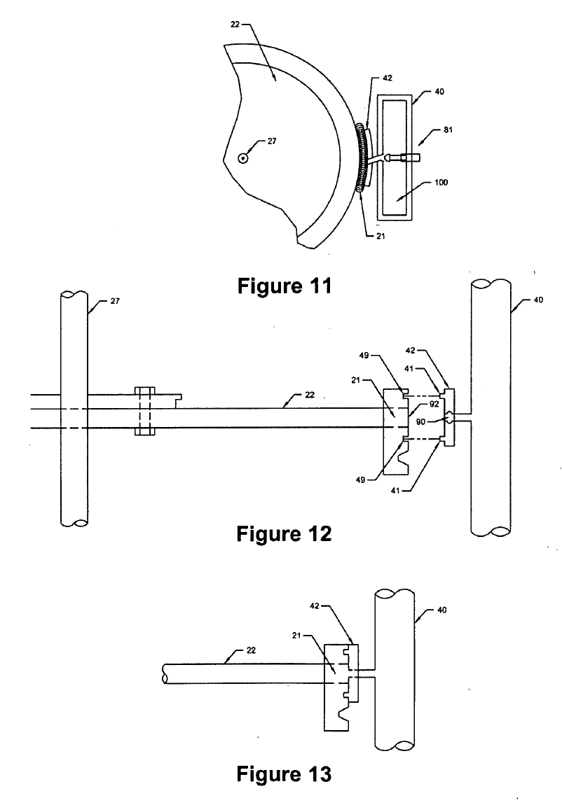

FIG. 11 illustrates the relation between air shot device 40 and fins 21 of turbine wheel 22. It should be noted that this view is a partial view also showing certain components in cross-section. For instance, the air shot device is shown in cross-section as well as fin portion of the turbine wheel thereby showing the curved configuration of the turbine fins 21. Compressed air/gas flowing from volume 100 through valve assembly 81 is then guided to the turbine fins 21 via nozzle guide 42. Nozzle guide 42 is shown in more detail in FIG. 12. Nozzle guide 42 is connected to airline 46. Nozzle guide 42 includes a nozzle 90 and guide rails 41. Turbine wheel 22 includes guide grooves 49 which mate with guide rails 41 of the nozzle guide 42. Air/gas flows through nozzle 90 into openings 92.

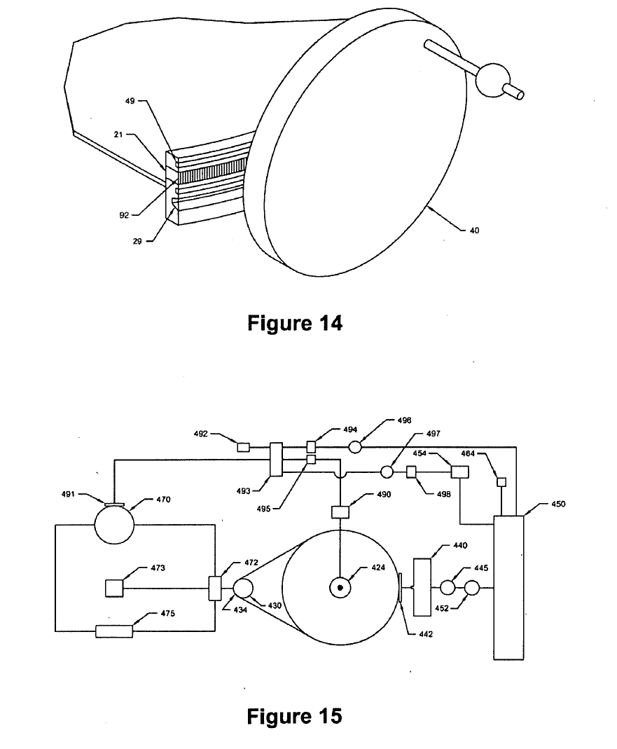

FIG. 13 shows the air shot device 40, nozzle guide 42 and turbine wheel 22 in their assembled states. It should be noted that the air gap between nozzle guide 42 and turbine wheel 22 is preferably less than 0.005 inches without contacting turbine wheel 22. FIG. 14 is a simplified view of the turbine wheel with the air shot device. This figure shows that the turbine blades 21 are mostly enclosed in the turbine wheel with only opening 92 exposing the blades.

A second exemplary embodiment of a vehicle incorporating the compressed air turbine generation system is represented schematically in FIG. 15. This embodiment is generally the same as shown in FIG. 2, except that the regenerative braking system that produces electricity and the electric starter motor are eliminated and an air/gas starter 690 now engages flywheel 624. Regenerative compressor 691 compresses air/gas into tank 693. When start up is required a solenoid valve 695 opens and allows air/gas to flow to air starter 690. The air tank 693 can be pressurized from a stationary compressor 692. When air tank 693 is at capacity from regenerative braking, a solenoid valve 694 opens and the air/gas flows through a check valve 696 to the tank array 650. Air tank 693 and tank array 650 can both be pressurized by the on board air/gas compressor 654 via solenoid valve 698 and check valve 697.

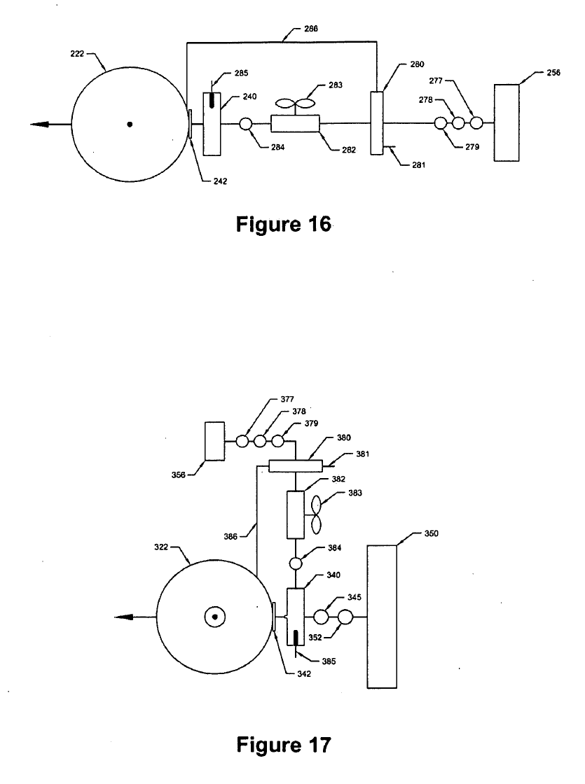

FIG. 16 schematically illustrates a third exemplary embodiment of a vehicle incorporating the compressed air turbine generation system. In this embodiment the tank array and pressure regulator of the previous embodiments are replaced with a system that runs off of liquefied air/gas. The liquefied air/gas is stored in an appropriate flask 456, such as a Dewar Flask or other tank of similar construction having a vacuum filled double wall with silvered surfaces facing the vacuum. Between the flask 456 and the rest of the system is a solenoid valve 477 that shuts down the system if there is system failure downstream. When the system is operating, a pump 478 pumps a measured amount of liquid through check valve 479 to a pre-heater 480. After the liquefied air/gas is pre-heated it goes through a heat exchanger 482 which depending on the climate or positioning may or may not have the fan 483. The heat exchanger 482 is made of frost proof materials and changes the liquefied air/gas back to air/gas. The expanded air/gas goes through a pressure-reducing valve 484 into the air shot device 440, which may or may not have an electric coil 485. The expanded air/gas is released in measured amounts to the turbine 422 through air guide 442. The spent air/gas from the turbine is captured and sent back by means of 486 to the pre-heater 480. After pre-heating the liquefied air/gas it exits to the atmosphere through pipe 481. The remainder of the system from the turbine 422 forward (not shown) can be the same as any of the previous embodiments.

A fourth exemplary embodiment of a vehicle incorporating the compressed air turbine generation system is represented schematically in FIG. 17. FIG. 17 illustrates a hybrid incorporating a liquefied air/gas system and a compressed air/gas system, which are in the same vehicle and can be used together or alternately depending on range and horsepower requirements. The remainder of the system from the turbine 522 forward (not shown) can be the same as any of the previous embodiments.

The liquefied air/gas system is similar to that described in the third embodiment above (FIG. 16). Liquefied air/gas is stored in a Dewar Flask 556 or similar tank. Between the flask 556 and the rest of the system is a solenoid valve 577 that shuts down the system if there is system failure downstream. When the system is operating, a pump 578 pumps a measured amount through check valve 579 to a pre-heater 580. After the liquefied air/gas is pre-heated it goes through a heat exchanger 582 which depending on the climate or positioning may or may not require fan 583. Here again, the heat exchanger 582 is made of frost proof materials and changes the liquefied air/gas back to air/gas. The expanded air/gas goes through a pressure-reducing valve 584 into the air shot device 540, which may or may not have an electric coil 585. The expanded air/gas is released in measured amounts to the turbine 522 through air guide 542. The spent air/gas from the turbine is captured and sent back by means of 586 to the pre-heater 580. After pre-heating the liquefied air/gas it exits to the atmosphere through pipe 581.

Also shown in FIG. 17 is a compressed air system similar to those shown in FIGS. 2 and 15. Compressed air/gas is transported from the tanks 550 to air shot 540. Air/gas tanks 550 store compressed air/gas at a pressure between 3,000 and 10,000 PSI. The compressed gas is regulated from tank pressure with regulator 545. Regulator 545 reduces the tank pressure to a lower pressure in order to conserve the volume of gas in the tanks. Regulated gas then flows from regulator 545 to air shot device 540. The system also includes a system shut-off valve 552 to conserve compressed air. The compressed air/gas and liquefied air/gas systems can be used alternately or in combination by controlling solenoid valves 552 and 577.

It is to be appreciated that the flow of air/gas and/or air shots from the tanks to the turbine in at least several of the embodiments are regulated and controlled by a suitable controller typically comprising a microprocessor. The controller can control: the pressure of the air/gas within the air shot reservoir; the frequency of air shots being released from the reservoir; the use of a starter motor as necessary to spin the turbine to speed; and the distribution of electrical current between the capacitors, batteries, motors and generators as applicable. Accordingly, the entire system can be optimized for maximum economy or in other instances maximum performance or any combination thereof.

The present invention has been described with some degree of particularity directed to certain exemplary embodiments. Those of skill in the art, though, will recognize that certain modifications, permutations, additions and sub-combinations thereof are within the true spirit and scope of the various embodiments. It should also be understood that methods, which may include any steps inherent in any of the disclosed embodiments, are also contemplated.

I claim:

1. A system comprising:
at least one electrical generator;
a source of compressed gas;
a turbine, the turbine having a plurality of fins and being operatively coupled to the at least one generator to cause the at least one generator to generate an electrical charge when the turbine is operated;
a nozzle, the nozzle being located in close proximity to the plurality of fins; and
a air shot device, the gas shot being operatively disposed between and fluidly coupled with the compressed air/gas source and the nozzle, the air shot device adapted to provided metered and intermittent volumes of compressed gas through the nozzle and against one or more fins of the plurality of fins.

2. The system of claim 1 further comprising a pressure regulator, the pressure regulator being fluidly coupled between the compressed air/gas source and the air shot device.

3. The system of claim 1 wherein the air shot device comprises:
a reservoir defining a predetermined volume;
an intake fluidly coupled with the compressed gas source;
an outlet fluidly coupled with the nozzle; and
a valve assembly, the valve assembly adapted to open and close the outlet thereby permitting the intermittent release of compressed gas to the nozzle.

4. The system of claim 1, wherein the reservoir is generally frustoconically shaped with the outlet being located proximate an apex thereof.

5. The system of claim 1, further including an electricity storage device electrically coupled to the electrical generator.

6. A combination including the system of claim 1 incorporated into a vehicle, the combination also including one or more electrical motors mechanically coupled to one or more wheels of the vehicle and electrically coupled to one or both of the electrical generator and the electricity storage device.

7. The system of claim 1, further including a starter motor mechanically coupled to the turbine, the starter motor being adapted to spin the turbine to a predetermined speed.

8. The system of claim 1, wherein the electrical generator is further adapted to operate as a starter motor to spin the turbine to a predetermined speed upon startup.

9. The system of claim 7, wherein the starter motor comprises an air motor.

10. The combination of claim 6, wherein the vehicle does not include a bank of three or more batteries as an electricity storage device.

11. The system of claim 6, wherein the source of compressed gas comprises one or more tanks filled with compressed gas.

12. The system of claim 1, wherein the turbine comprises a disk having the plurality of fins located proximate the circumferential edge of the disk and being recessed inwardly from the circumferential edge, the disk being adapted to rotate about a stationary axle on bearings disposed between the axle and the disk.

13. The system of claim 11, further comprising a regenerative braking system comprising a compressor mechanically coupled with one or more wheels and adapted to compress air during deceleration and feed the compressed air to the one or more tanks.

14. The system of claim 1, wherein the source of compressed gas comprises a liquefied gas flask and liquefied gas stored therein.

15. A method comprising:
providing a turbine the turbine having a plurality of fins;
providing a generator operatively coupled to the turbine;
providing a source of compressed air and a nozzle fluidly coupled with the source of compressed air/gas; and
releasing intermittent shots of compressed gas of a predetermined volume through the nozzle and at the plurality of fins causing the turbine to maintain rotation.

16. The method of claim 15, further comprising providing a wheeled vehicle including one or more electrical motors electrically coupled to the generator and mechanically coupled to one or more wheels of the vehicle, propelling the vehicle by feeding electricity to the one or more electrical motors.

17. The method of claim 16 further comprising controlling a frequency of release of shots of compressed air/gas to maximize the efficient generation of electricity.

18. The method of claim 17, further comprising spinning the turbine on startup to a predetermined rotational speed using the generator as a startup motor powered by an associated electricity storage device prior to said releasing intermittent shots of compressed air/gas.

19. A vehicle comprising:
a source of compressed gas;
an air shot device adapted to intermittently release predetermined volumes of compressed gas originating from the source of compressed gas through an associated nozzle;
a turbine including a plurality of vanes adapted to rotate responsive to the compressed gas emanating from the nozzle and impinging on the vanes;
an electrical generator/motor operatively coupled to the turbine adapted to (i) spin the turbine to a predetermined speed upon startup and (ii) generate electrical current during normal operation of the turbine;
at least one electrical drive motor electrical coupled to the generator; and
two or more wheels with at least one wheel operatively coupled to the electrical drive motor.

20. The vehicle of claim 19, further comprising one or both of batteries and capacitors electrically coupled with the generator and the at least one electrical motor.
